(19) United States
(12) Patent Application Publication
(10) Pub. No.: US 2006/0084048 A1
(43) Pub. Date: Apr. 20, 2006

(54) Method for analyzing standards-based assessment data

(76) Inventors: Fay G. Sanford, Wildomar, CA (US); Anthony W. Tooley, Murrieta, CA (US)

Correspondence Address: William C. Steffin, Esq.;LEWIS, BRISBOIS, BISGAARD & SMITH LLP, Suite # 1200, 221 North Figueroa Street, Los Angeles, CA, 90012, US

(21) Appl. No.: 10/969,318

(22) Filed: Oct. 19, 2004

(51) Int. Cl. G09B 7/00

(52) U.S. Cl. 434/323

(57) ABSTRACT

A method for analyzing standards-based assessment data includes the steps of formulating a standards-based assessment of a plurality of academic content standards for administering to one or more students, the assessment based upon an existing set of academic content standards, generating a plurality of reports from administering the assessment for presenting at least one assessment result in a standards-based format, providing a methodology for analyzing the reports for identifying achievement problems of the students, and setting forth a plurality of parameters for developing an intervention strategy for improving the performance of the student or students.

### BACKGROUND OF THE INVENTION

1. Technical Field

The present invention relates to educational assessments. More specifically, the present invention relates to a method for analyzing standards-based assessment data that enables teachers to determine why students are not mastering a particular academic content standard and what interventions are necessary to correct achievement problems experienced by the students.

2. Background Art

The performance of students especially in kindergarten through 12^{th} grade has depreciated in recent years. Consequently, student performance is a major concern to state and federal education departments throughout the United States. Much effort has been expended and large amounts of taxpayer funds spent in an attempt to solve this problem of depreciating student performance. For example, more emphasis has been placed on attracting better qualified candidates to become teachers, on teacher education programs in state and private colleges and universities, and on mandatory continuing teacher education programs to ensure that teachers and instructors maintain state mandated credentials.

In addition to ensuring that teachers and instructors are suitably qualified and well trained, much emphasis has also been placed on the student-teacher statistics. For example, the student-to-teacher ratio has been exhaustively considered, i.e., reducing the number of students per class that a single teacher is charged with instructing. It is clearly evident that once the number of students exceeds a threshold level, the teacher can no longer provide the personal attention to each student that is necessary to ensure understanding the subject matter. Another consideration has been the tax revenues available to fund both the during-class and after-class programs considered by school districts to be necessary in order to provide an adequate education to the students. In many states, the funds allocated for school districts and education programs are raised by local property taxes. However, some states now have limits on how high property taxes may be raised annually. Consequently, many states seek out alternative methods of raising funds for use by local school districts. One of those alternative methods is a lottery system that now exists in many states, wherein a portion of the funds raise by selling lottery tickets for a chance drawing is directed to state education funding. Both the student-to-teacher ratio and the funding issues are relevant in improving student performance.

Yet another consideration in improving student performance is directed to the students themselves, i.e., the social-economic environment in which many students are raised. Many inner-city students, i.e., in large urban areas, are the children of immigrants and may be the first generation of children in those families raised in the United States. In many situations, the language spoken in the home environment by the parents, and consequently by the children, may not be English. Consequently, when the child reaches the age mandated to begin classroom instruction, the child does not have a working knowledge of English which results in a serious handicap. Some school districts have addressed this situation by either forcing the new students into an all English language environment or have attempted to accommodate the students by teaching them in their native language. Each of these alternatives creates further challenges.

Notwithstanding how these challenges are addressed, the education department or agency of each state or other responsible political subdivision must organize academic content guidelines for use by local school districts. These content guidelines typically identified as “academic content standards” are developed, revised and distributed to all school districts. Each academic subject and sub-category thereof has an academic content standard directed thereto. The “content standard” may be defined as a precisely articulated academic objective usually stated in behavior terms. Academic content standards may be developed at state, district or site levels. Thus, a set of academic content standards may define a state-mandated curriculum for any particular academic area. For example, a set of content standards may define the state-mandated core curriculum for second grade English/Language Arts.

Each school district in each state follows the corresponding state-mandated academic content standards in their teaching program. The generally accepted means by which a local school district determines if the state academic content standards are successfully met in their respective school districts is to test students on the subject matter taught in the classroom. These tests are typically referred to as academic assessments where an academic assessment can be defined as a set of items, typically test questions, that constitute a measurement tool for teachers to determine what a group of students know or do not know with regard to the specific academic content, i.e., the subject matter taught in the classroom. In the past, the academic assessments were graded and the specific test results were compiled in a report that was distributed to the teacher or instructor for the specific subject or grade level tested. The teacher or instructor was then directed to study the reports and attempt to develop a solution to solve the deficiencies associated with assessment items, i.e., test questions, that were incorrectly answered by a high percentage of the class.

By reviewing the results of academic assessments of the past, three main questions have been identified. Those questions included (1) Which academic content standards are not being mastered by the students?, (2) Why are the students not mastering those particular academic content standards?, and (3) What do teachers need to do, i.e., what action is necessary, to eliminate the deficiencies associated with the academic content standards not being mastered by the students? Armed with this approach, solutions developed in the past were employed to address the question of which academic content standards were not being mastered by the students. One of those solutions was to measure the knowledge of the students vis-a-vis testing results for the subject matter of each content standard in the past. Thereafter, the test results were again provided to the respective teachers. The results were incorporated into a report addressing which academic content standards were not being mastered by the students. The respective teachers were once again assigned the task of studying the report in order to develop an innovative solution to solve the problem so that the students would master the content standards. However, the quality of this solution appears to be dependent mainly on the validity and reliability of the assessment items, typically test questions, employed to test the students knowledge. These prior art solutions were not very successful since the individual teachers were already assigned more tasks than they could accomplish in the time allotted and “solutions” would vary depending on the individual teacher performing the analysis. Further, the problem of determining why the students were not mastering the particular academic content standard was not addressed.

Several educational methods and apparatus have been known in the past that are employed to assess a student's progress in the subject matter to which they are exposed. One of these is disclosed in U.S. Pat. No. 5,934,909 to Ho et al. entitled Methods And Apparatus To Assess And Enhance A Student's Understanding In A Subject. Ho et al. disclose an educational method and system that purportedly automatically assess and enhances a student's understanding in a subject, and, based on a student's understanding, individually-tailored tests are generated, difficulties of which are geared towards the student's level of understanding in the subject. It is further contended that the student not only can use the tests to prepare for an examination, but can also use the tests to learn the subject. In one preferred embodiment, Ho et al. state that the assessment and enhancement take into account the student's past performance. In another preferred embodiment, Ho et al. allege that the invented method and system are based upon the latest test results from the latest test taken by the student on the subject, which is divided in line-items. In yet another preferred embodiment, Ho et al. purport that at least one line-item is more difficult than another line-item where the latest test includes questions with different line-items.

Ho et al. purportedly disclose a score generator coupled to a recommendation generator which in one embodiment includes an inference engine, and in another embodiment includes a pre-requisite analyzer. Ho et al. discloses that the recommendation generator is coupled to a report generator and a question generator. The score generator preferably accesses the student's prior-to-the-latest test results in the student's test results table and the latest test results so as to generate one overall score for each set of questions that belongs to the same line-item. In one embodiment, the prior-to-the-latest test results is defined as the test results from the test immediately before the latest test. Both the pre-requisite analyzer and the inference engine in the recommendation generator are represented by Ho et al. as being able to generate recommendations based on the student's test results table. The pre-requisite analyzer accesses pre-requisite rules which according to Ho et al. are based on the complexity levels of the line-items, and determines a complexity-hierarchy among the line-items. Then, applying the complexity-hierarchy to the test results table, Ho et al. note that the pre-requisite analyzer determines the student's level of understanding in the subject to provide recommendations for the student. Next, Ho et al. note that the inference engine accesses a set of relationship rules that define the relationship among the line items and the subject. Then applying the set of relationship rules to the student's test results table, Ho et al. state that the inference engine determines the student's level of understanding in the subject to provide recommendations to the student.

U.S. Pat. No. 6,491,525 to Hersh allegedly discloses an application of multi-media technology to psychological and educational assessment tools. This patent allegedly discloses a method of evaluative probing that avoids the inherent bias occurring through differences in language or dialect.

U.S. Pat. No. 6,540,520 to Johnson allegedly discloses an intelligent tutoring methodology using consistency rules to improve meaningful response. This invention allegedly provides a tutoring system that uses fundamental rule sets and artificial intelligence to identify problem-solving principles overlooked or not understood by the student.

U.S. Pat. No. 6,551,109 to Rudmik allegedly discloses a computerized method of and system for learning. This invention allegedly discloses a computerized learning system that periodically reviews a student's knowledge and identifies areas requiring further review.

U.S. Pat. No. 6,585,517 to Wasowicz allegedly discloses a phonological awareness, phonological processing, and reading skill training system and method. This patent allegedly discloses a method for training a user to discriminate sounds and evaluating the user's auditory processing, phonological awareness, phonological processing, and reading skills.

There is a need in the art for a method for analyzing standards-based assessment data which will enable grade level educational teams, content level educational teams, and classroom teachers, typically kindergarten-through-12th grade, to determine, based upon testing results (1) which academic content standards are not being adequately mastered by the students, (2) why students are not mastering the subject matter of a particular academic content standard, and (3) what interventions, once integrated into the educational program by teachers, will correct the achievement problems experienced by the students.

### DISCLOSURE OF THE INVENTION

Briefly, and in general terms, the present invention provides a new and improved method for analyzing standards-based assessment data for enabling grade level teams, content level teams, and classroom teachers, typically kindergarten-through-12th grade, to determine, based upon testing results (1) which academic content standards are not being adequately mastered by the students, (2) why students are not mastering the subject matter of a particular academic content standard, and (3) what interventions, once integrated into the educational program by teachers, will correct the achievement problems experienced by the students.

In general, the inventive method for analyzing standards-based assessment data is an analytical method or process intended to enable educators to better utilize the results of standards-based assessment reports, i.e., reports compiled to disclose the results of academic tests. The inventive method enables educators to detect and identify deficiencies in state and school district mandated academic content standards, i.e., the subject matter being taught, to develop necessary intervention strategies to arrest the achievement problems experienced by the students, and to amend instructional practices in order to enhance student achievement and performance. The inventive analytical method is employed in conjunction with a software program and a standards-based item bank, i.e., question bank. Each of these components is designed to closely operate in conjunction with the other components so that the items or questions stored in the item bank, the operations performed by the software program, and the analytical method of the present invention are all in compliance.

In the present invention, a standards-based assessment, i.e., academic test, is formulated by incorporating a suitable set of items or questions provided by a standards-based item bank, i.e., question bank, along with demographic and test specification data. The items or questions are directed to a plurality of academic content standards for administering to a plurality of students in a testing environment. Each item or question includes a correct answer and one or more and preferably at least three, wrong answers or Distractors. The distractors or incorrect answers must be configured so that they reflect what is likely the most often made mistakes, i.e., cognitive disconnects, by students which result in the selection of those wrong answers. Each anticipated incorrect answer includes a rationale which is documented and explains why a student might select that incorrect answer. This design is consistent with assessment items, i.e., test questions, that are compliant with the inventive process.

After being administered to the students, the standards-based assessment is scored and an assessment result is provided which is processed and integrated with pacing, i.e., scheduling, and instructional program data. Thereafter, a plurality of reports are generated which present the assessment result in a standards-based format which is very useful to educators. The reports illustrate information including the percentage of students that mastered each item or question and each academic content standard. The reports can be conveniently manipulated by teachers using computer point and click methods and viewed on a monitor screen or printed out in different formats. For example, one report format emphasizes data particular to each specific item or question while another format emphasizes the specific academic content standard of that subject matter, while a third format is directed to the detail of a specific item or question.

Thereafter, a methodology is provided for analyzing the reports in an attempt to identify specific achievement problems suffered by the students. In addition to the method of listing the percentage of students that selected the correct answer and the percentage of students that selected an incorrect answer, the plurality of reports that disclose assessment results by-item or by-standard may also show the pacing status, i.e., scheduling status. The pacing status is intended to illustrate the extent or degree to which a particular academic content standard, i.e., subject matter, has been presented to the students via classroom instruction in the current academic year. The pacing or scheduling status can be shown, for example, by dividing the reports into a plurality of sections where each section separately indicates the extent to which the academic content standards have been addressed. Further, the extent to which each of the academic content standards has been addressed can be separately indicated by one of a plurality of different text fonts used for the writing in each separate section of the reports. Additionally, each separate text font in the reports can represent a particular color where each separate color indicates the extent to which the academic content standards have been presented to the students in the classroom. In the alternative, the pacing status, i.e., scheduling status, can be illustrated by a background color printed directly onto the plurality of reports. For example, each separate section of the reports can be illustrated in a different background color where each separate background color indicates the extent to which the academic content standards have been presented to the students in the classroom. A background color legend could be printed directly onto the reports so that the background color code of each section could be translated into the expected mastery level of the students who have experienced a specific exposure level for the particular academic content standard.

The methodology of analyzing the reports provided by the present invention enables the different data to be compared. For example, suppose that the percentage of students who selected the incorrect answer noted in a particular section of the report is very high. Simultaneously, suppose that the text font used for the writing in the same section of the report (or alternately the background color code used for the same section of the report) indicates that the subject matter should be mastered or well practiced based upon the pacing status, i.e., scheduling status. This inconsistency exposed by this analysis indicates that a deficiency exists with this academic content standard. Typically, this academic content standard is selected for further review and analysis and the items or questions associated with this academic content standard will also be reviewed. The specific items or questions associated with the academic content standard can be reviewed on the report format that addresses the detail of a specific item or question. This report format includes the documented rationale that explains why a student might select a particular incorrect answer via a rationale response analysis. Academic content standards and the items or questions contained therein that are selected for additional review and analysis are referred to as “weak standards” and “weak items”, i.e., particular academic content standards in which the percentage of incorrect answers to the items or questions presented to test the students knowledge in the relevant subject matter is high. This assumes that the students have had adequate exposure to the subject matter to be able to answer the items or questions correctly. This step in the inventive method enables the detection of student achievement problems.

Next, guidelines are provided for placing the academic content standards in an instructional context for determining when the content standards were presented to the students during the academic year. The instructional materials are then studied to determine where and when the academic content standard being analyzed was taught in the current instructional program. The report format that addresses the detail of a specific item or question also specifies the particular instructional program used and the location within that instructional program that the academic content standard being analyzed was taught. By studying the cognitive rationale from the rationale response analysis that suggests why the students selected the wrong answer and determining where and when the academic content standard being analyzed was taught, the cognitive disconnect of the students can be identified. Using this information, a determination of how the student cognitive disconnect could have occurred during classroom instruction, but more importantly, how it should be eliminated. Once these plurality of parameters are identified and set forth, an intervention strategy can be developed for improving the performance of the students. The complexity of the intervention strategy is dependent upon the severity of the cognitive disconnect that the student has acquired.

In a preferred embodiment, the method for analyzing standards-based assessment data for assisting educators in evaluating standards-based assessment results in its most fundamental form comprises the steps of formulating a standards-based assessment of a plurality of academic content standards for administering to one or more students where the assessment is based upon an existing set of academic content standards, generating a plurality of reports from administering the assessment for presenting at least one assessment result in a standards-based format, providing a methodology for analyzing the reports for identifying achievement problems of the student or students, and setting forth a plurality of parameters for developing an intervention strategy for improving the performance of the student or students.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1A is a first of two sheets of a flowchart illustrating the steps of a method for analyzing standards-based assessment data of the present invention resulting from the administration of standards-based assessment tests to at least one student.

FIG. 1B is a second of two sheets of the flowchart illustrating the steps of the method for analyzing standards-based assessment data of FIG. 1 resulting from the administration of standards-based assessment tests to at least one student.

FIGS. 2A-2C show a computer generated By-Item Report which reports an assessment in a standards-based format by item, i.e. questions 1-24, which provides detailed information in percentages directed to the assessment data, and the pacing status is shown by different text fonts.

FIG. 2D shows a further illustration of the computer generated By-Item Report of FIGS. 2A-2C exhibiting a chart showing the percentage of students choosing each of the available responses to each of the items, i.e., questions 1-24.

FIGS. 2E-2F shows another illustration of the computer generated By-Item Report of FIGS. 2A-2C exhibiting a chart showing the percent correct score for each student and how each student scored for each of the items appearing in the assessment.

FIGS. 3A-3C show a computer generated By-Standard Report which reports an assessment by academic content standard which provides detailed information in percentages of correct and incorrect answered items, and the pacing status is shown by different text fonts.

FIGS. 4A-4C show an expanded version of the computer generated By-Standard Report of FIGS. 3A-3C wherein a user has selected a particular academic content standard of interest to exhibit each item in that assessment that measures that particular academic content standard, and the pacing status is shown by different text fonts.

FIG. 5 shows a computer generated Item Detail Report and represents the report format generated when a user selects a particular item within a particular academic content standard from either the By-Item Report or the By-Standard Report for explaining the item of interest in detail.

### DEFINITIONS

The following terms utilized in the Detailed Description Of The Invention are defined in this section of the patent application.

1. Academic Content Standard or Content Standard is defined as a precisely articulated academic objective usually stated in behavior terms and may be developed by state, district or local education authorities. A set of Academic Content Standards define the mandated curriculum for any particular academic area, such as, the state-mandated core curriculum for second grade English/Language arts.

2. Achievement Problems are defined as difficulties experienced by students which are associated with understanding and applying the subject matter of the academic content standards, for example, a student's inability to demonstrate the knowledge prompted by a selected assessment such as when a cognitive disconnect has been identified.

3. Assessment or Academic Assessment is defined as a set of Items or questions that constitute a measurement tool for educators to determine what a group of students know or do not know with regard to specific academic content, and is essentially synonymous to the term “test”.

4. Assessment Result is defined as the results of a Standards-Based Assessment that has been scored or graded by a web-based or locally stored assessment data system after administering to one or more students.

5. Cognitive Disconnect is defined as a mental error that leads to the most often made mistakes by students resulting in the selection of a wrong answer to an item or question in a standards-based assessment or test.

6. Cognitive Rationale is defined as the reasoning based upon Wrong Answer Analysis, i.e., a rational response analysis, that suggests why a student selected a wrong answer to an item or question in a standards-based assessment, which can assist in the identification of the cognitive disconnect of the student. A rationale for each wrong answer in a standards-based assessment or test which explains why a student might select a particular wrong answer is documented during the item or question writing process with one or more explanatory sentences and is then stored in an assessment data system that houses the items or questions of the standards-based assessment.

7. Content Level Team is defined as a group of teachers that evaluate assessment or test results data from the perspective of specific subject matter such as algebra or English.

8. Correct Response is defined as the correct or most correct choice for a Selected Response Item.

9. Distractor is defined as an incorrect response in a Selected Response Item where for any particular Selected Response Item, there may be one, two or more Distractors and one correct response.

10. Educator's Assessment Data Management System is defined as a web-based or locally stored software that functions to archives assessment (test) and demographic data, performs routine data analysis, prepares reports, delivers questions for a standards-based item bank, and provides computerized support for the Method for Analyzing Standards-Based Assessment Data.

11. Form is defined as a set of items or questions that are configured to serve as an Assessment (test) to be administered to students to measure their mastery of a particular set of academic content standards. An Assessment Form can be configured in a variety of ways when using a standards-based item bank so as to include a wide or narrow set of standards or to include each assessed standard with many or few items or questions.

12. Grade Level Team is defined as a group of teachers that evaluate assessment or test results data from the perspective of a particular grade level.

13. INSPECT is a trademarked name for a standards-based item bank.

14. Instructional Context is defined as instructional program information that pertains to where and when a particular academic content standard is taught during the current instructional year and is typically available from a web-based or locally stored assessment data system.

15. Intervention strategy is defined as a plan for overcoming the achievement problems suffered by the students and, once implemented, will improve the overall performance of the students.

16. Item is defined as a single question in a set of Items or questions that are utilized to create an Assessment Form. Items are not referred to as questions because Items are not always phrased in the interrogative. Informally, the terms Item and questions are generally synonymous.

17. Off the Shelf (OTS) Assessment is defined as an Assessment (test) that is configured with a prescribed set of Items or questions that do not change, that is, an OTS Assessment is static as opposed to an Assessment Form created with a Standards-Based Item Bank which is dynamic.

18. Pacing Status of an Academic Content Standard is defined as the degree or extent to which that particular Academic Content Standard have been presented by instruction in the current academic year. An Academic Content Standard may have been
(a) Not Exposed which means that the content standard has not yet been presented to students by instruction;
(b) Introduced which means that the content standard has been presented to students by instruction once but not yet practiced;
(c) Practiced which means that the content standard has been Introduced and has been practiced for several sessions; or
(d) Mastered which means that the content standard has been presented to the extent that the content standard should have been mastered by the students.
   The Pacing Status of an Academic Content Standard for any particular school district is determined by the Pacing Guide published by that school district.

19. Parameters are defined as the characteristics of an intervention strategy and may include:
(a) the prevalent cognitive disconnect(s) that resulted in a student choosing an incorrect answer;
(b) the amount of exposure to an academic content standard afforded a student prior to the administration of a standards-based assessment, i.e., the pacing status; and
(c) the instructional context identifying when and where the subject matter was taught in the teaching program of the school district.

20. Plurality of Standards-Based Assessment Reports is defined as a plurality of standards-based assessment reports generated by a web-based or locally stored software for evaluating the results of the standards-based Assessment, i.e., reports compiled to disclose the results of academic tests, and include one or more of the following.

(a) By-Item Report is defined as a report of a standards-based assessment or test in a standards-based format by item or question and is produced by a web-based or locally stored assessment data system. The By-Item Report can appear on a computer monitor or be printed out.

(b) By-Standard Report is defined as a report of a standards-based assessment or test in a standards-based format by academic content standard (rather than by item or question) and is produced by a web-based or locally stored assessment data system upon command by a teacher. The By-Standard Report can appear on a computer monitor or be printed out, and is necessary to properly evaluate the results of the standards-based assessment.

(c) Item Detail Report is defined as a report format provided by a web-based or locally stored assessment data system and is generated when point and click techniques are applied to an item or question within a display of a particular academic content standard. The Item Detail Report explains the item or question of interest including the Stem, Distractors, Correct Response, percentage of students selecting the correct answer and Distractors, rationale, and instructional context. The Item Detail Report is necessary to properly evaluate the results of the standards-based assessment.

21. Standards-Based Assessment is defined as an Assessment Form that is created flexibly from a Standards-Based Item Bank, or is predetermined and targeted towards a specific set of Academic Content Standards.

22. Standards-Based Format is defined as a format in which a plurality of standards-based assessment reports are illustrated, the reports, which are manipulated by computer point and click methods, exhibit information directed to the percentage of students that master each item or academic content standard.

23. Selected Response Item is defined as an Item or question that presents a stimulus (i.e., the Stem) which elicits a response from the student where the student selects from a set of possible responses including Distractors and a single Correct Response.

24. Standards-Based Item Bank is defined as a collection of Assessment Items (i.e., tests) where each Item specifically targets an Academic Content Standard. A Standards-Based Item Bank differs from an Off the Shelf (OTS) Assessment in that the OTS Assessment is static, whereas the Standards-Based Item Bank is a collection of Items that can be continuously configured dynamically as desired to create Assessments to satisfy unique requirements or specifications.

25. Stem is defined as the stimulus portion of an Item or question and is that portion of the Item that solicits a response from the student.

26. Method Compliant Standards-Based Assessment Item is defined as a Standards-Based Assessment Item that is compliant with the Method for Analyzing Standards-Based Assessment Data by satisfying the following criteria:
(a) The Item or question must be closely aligned to the academic content stipulated by the Academic Content Standard it is designed to match;
(b) The Item or question must be closely aligned to the skill level prescribed by the Academic Content Standard it is designed to match (or if the Item is calibrated higher or lower than the stipulated skill level, then it must be indicated as such);
(c) The Item or question must to the greatest extent possible isolate the Academic Content Standard being measured (i.e., not measure any other Academic Content Standards unless absolutely necessary);
(d) The Item or question must have “Distractors” (i.e., incorrect response choices) that reflect the most likely cognitive disconnects of students that have received instruction in the Academic Content Standard but do not choose the Correct Response; and
(e) The Items must have the rationale for each Distractor thoroughly documented, that is, explain the most likely thought process(es) that would lead students to select that particular incorrect response.

27. Wrong Answer Analysis is defined as a technique for analyzing the results of an Assessment Item (test question) when administered to a significant number of students, for example, more than thirty students at a minimum. Higher numbers of students results in a more accurate analysis conclusion.

### DETAILED DESCRIPTION OF THE INVENTION

The present invention is a method for analyzing standards-based assessment data 100, hereinafter method 100, which will enable grade level teams, content level teams, and classroom teachers, typically kindergarten-through-12th grade, to determine based upon testing results (1) which academic content standards are not being adequately mastered by the students, (2) why students are not mastering the subject matter of a particular academic content standard, and (3) what interventions, once integrated into the educational program by teachers, will correct the achievement problems experienced by the students.

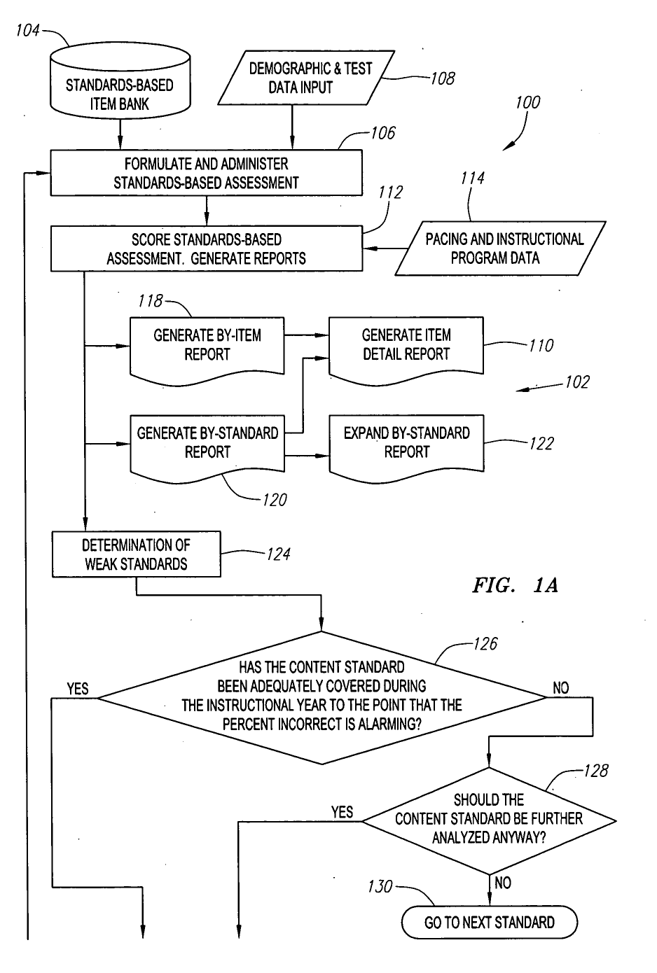

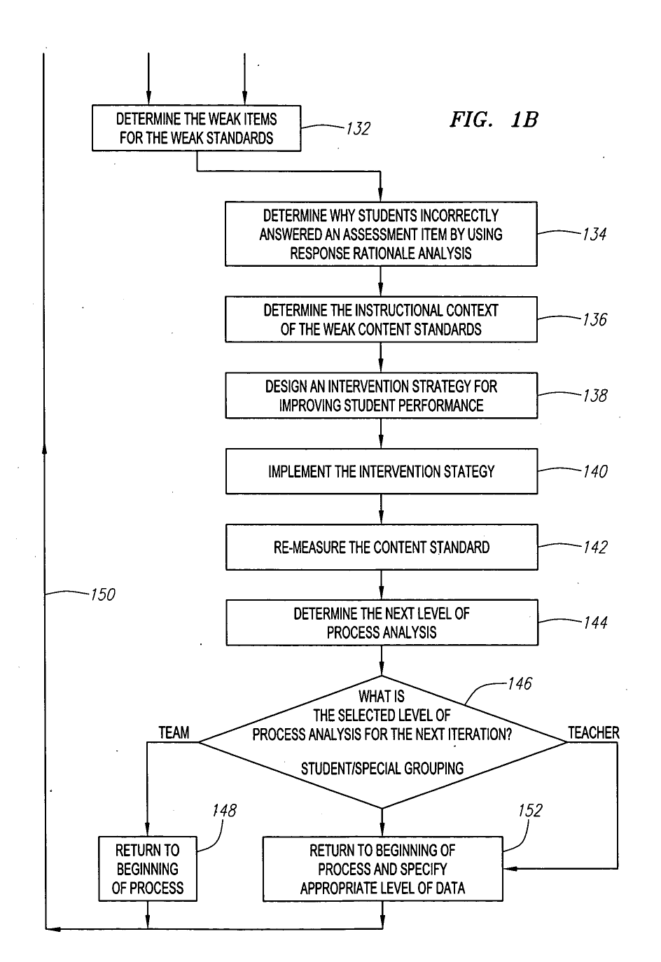

In general, the method 100 for analyzing standards-based assessment data is an analytical method or process designed to enable educators to effectively analyze and better utilize the results of a plurality of standards-based assessment reports 102 containing standards-based assessment data, i.e., reports 102 compiled to disclose the results of academic tests shown in FIG. 1A. The inventive method 100 enables educators (a) to detect and identify deficiencies with state and school district mandated academic content standards, i.e., the subject matter being taught, (b) to develop necessary intervention strategies to arrest the achievement problems experienced by the students, and (c) to amend instructional practices in order to enhance student achievement and performance. The inventive analytical method 100 is employed in conjunction with a software program incorporated within a web-based or locally stored assessment data system and a standards-based item bank 104, i.e., test question bank, which are discussed herein below. Each of these components is designed to closely operate in conjunction with the other components so that the items or questions stored in the item bank 104, the operations performed by the software program, and the analytical method 100 of the present invention are all in compliance. Therefore, the design of each of the components is based upon the academic content standards being taught and tested, thus, the term standards-based.

The method 100 of the present invention for analyzing standards-based assessment data operates in conjunction with and is supported by the software program incorporated within a web-based or locally stored assessment data system. A suitable assessment data system for use with the inventive analytical method 100 is the Educator's Assessment Data Management System developed by Adrylan Communications, Inc., P.O. Box #1150, Murrieta, Calif. 92564. This assessment data system serves several vital functions in the present invention including (1) an assessment data storage medium for storing assessment (test) and demographic data, (2) performing routine data analysis, (3) report generation via a software module that prepares assessment reports in printed form, file form or as a video image on a computer monitor, (4) a means for delivering assessment items, i.e., tests, for the standards-based item bank 104 used in conjunction with the method 100, and (5) providing computerized support for the method 100 for analyzing standards-based assessment data. The support provided by the assessment data system is necessary to ensure the proper operation of the method 100.

The method 100 also operates in conjunction with the standards-based item bank 104, i.e., test question bank, shown in FIG. 1A. The item bank 104 is a collection of assessment items or tests where each item is specifically targeted to an academic content standard and can be continuously configured dynamically, as desired. The dynamic configuring feature enables assessments, i.e., tests, to be created to satisfy unique requirements or specifications as opposed to an Off the Shelf Assessment which is static in nature and thus does not change since it is targeted towards a specific set of academic content standards. The standards-based item bank 104 is incorporated within the data storage medium of the assessment data system. However, the essence of the standards-based item bank 104 is not tied to an automated storage medium. The items or test questions could be recorded in written form on file cards or stored in a conventional file cabinet. A suitable standards-based item bank 104 for use with the inventive analytical method 100 for analyzing standards-based assessment data is the Inspect Item Bank developed by Sanford Systems, Inc., P.O. Box #1502, Wildomar, Calif. 92595. The Inspect Item Bank is designed to be compliant with the method 100 and is currently available for use with certain State academic content standards and can be reconfigured for any particular State academic content standards of interest. Although a standards-based item bank 104 is necessary to ensure the proper operation of the method 100, a different standards-based item bank (i.e., an item bank other than the Inspect Item Bank) can be employed to ensure the proper operation of the method 100 assuming that the different item bank is also compliant with the method 100.

The requirement that the standards-based item bank 104 be compliant with the method 100 means that standards-based assessment items provided by the standards-based item bank 104 satisfy certain criteria. Those criteria include (a) that the item or question must be closely aligned to the academic content stipulated by the Academic Content Standard it is designed to match, (b) that the item or question must be closely aligned to the skill level prescribed by the Academic Content Standard it is designed to match (or if the item is calibrated higher or lower than the stipulated skill level, then it must be indicated as such), (c) that the item or question must to the greatest extent possible isolate the Academic Content Standard being measured (i.e., not measure any other Academic Content Standards unless absolutely necessary), (d) that the item or question must have “Distractors” (i.e., incorrect response choices) that reflect the most likely cognitive disconnects of students that have received instruction in the Academic Content Standard but do not choose the Correct Response, and (e) that the items must have the rationale for each Distractor thoroughly documented, that is, explain the most likely thought process(es) that would lead students to select that particular incorrect response. In this manner, the items or questions of the assessments or tests are each intimately related, i.e., compliant, to promote the analytical method 100 of the present invention as will be discussed in more detail herein below.

The method 100 for analyzing standards-based assessment data will now be described in conjunction with the flowchart set forth in FIGS. 1A and 1B. The first step in the method 100 is formulating and administering a standards-based assessment 106 as shown in FIG. 1A. The standards-based assessment 106 which is an academic test is formulated by incorporating a suitable set of items or questions provided by the standards-based item bank 104 (or test question bank) along with demographic and test specification data 108. The demographic and test specification data 108 is typically provided by the relevant school district and thus this data 108 varies from district-to-district. The formulation of this standards-based assessment 106 is designed to be compliant with the method 100. The items or questions provided by the standards-based item bank 104 are directed to a plurality of academic content standards for administering to one or more students in a testing or examination environment.

In particular, a selected response, standards-based assessment is flexibly created by employing the dynamic standards-based item bank 104 shown in FIG. 1A. In the alternative, an equivalent item bank or a static off-the-shelf standards-based assessment that is also compliant with the method 100 can be employed. This standards-based assessment is an assessment form, i.e., set of test questions configured to serve as an assessment which is administered to students to measure their mastery of a particular set of academic content standards established by the state education authority, local school district or other political authority. The purposes of the administration of the standards-based assessment are (a) to determine the degree to which students have mastered the academic content standards that have been taught in the classroom this far into the instructional year, or (b) to determine the degree to which students have mastered the academic content standards that have not yet been taught, or (c) both of the foregoing.

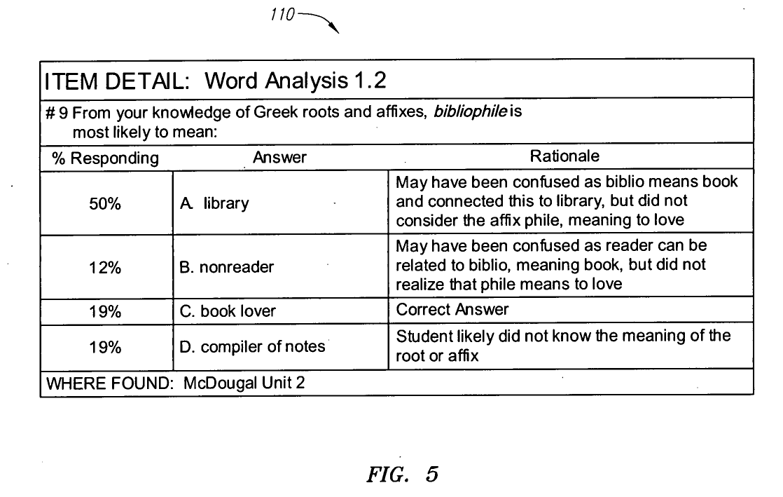

Each item or question of the standards-based assessment includes a correct answer and one or more and preferably at least three wrong answers, often referred to as distractors, as shown by an Item Detail Report 110 of FIGS. 1A and 5. These distractors or incorrect answers must be configured so that they reflect what is likely the most often made mistakes, i.e., cognitive disconnects, by students which result in the selection of those wrong answers given that the student has not fully mastered the academic content standard being evaluated by that item or question. The determination of whether the distractors, i.e., wrong answers, reflect the most prevalent student mistakes is decided by testing and education professionals during the item or question review process. This is standard criteria for items or questions developed for use with the standards-based item bank 104 which is compliant with the method 100. For each item or question that includes multiple distractors or wrong answers, a rationale for each wrong answer, i.e., anticipated student mistake, is documented during the item or question writing process with one or more explanatory sentences. The rationale for each wrong answer which explains why a student might select that particular wrong answer is then stored in the assessment data system or database that houses the items or questions of the standards-based assessment. Thus, the design of the items or questions having a single correct answer and multiple wrong answers including an explanatory rationale contribute to the standards-based item bank 104 being compliant with the method 100. The use of the Item Detail Report 110 will be explained in greater detail below in conjunction with FIG. 5.

The standards-based assessment or test has now been administered to the students. The next step in the method 100 is that the assessment data system processes and then scores the standards-based assessment 112 for providing an assessment result. In the next step of the method 100, the assessment result is integrated with pacing and instructional program data 114 unique to the relevant local school district to produce the set of standards-based assessment reports 102 as shown in FIG. 1A. The pacing and instructional program data 114 is employed to determine the pacing status of an academic content standard which is the degree or extent to which that particular academic content standard has been presented to the students by instruction in the current academic year. An academic content standard may have been (a) “not exposed” which means that the subject matter associated with academic content standard has not been presented to the students by instruction yet, (b) “introduced” which means that the subject matter of the academic content standard has been presented to the students by instruction once but not practiced yet, (c) “practiced” which means that the subject matter of the academic content standard has been introduced and then practiced for several sessions, or (d) “mastered” which means that the subject matter of the academic content standard has been presented and practiced to the extent that the academic content standard should have been mastered by the students. The pacing status of an academic content standard for any particular school district is determined by the pacing guide published by that school district. Thus, each local school district determines via its own pacing guide where in the curriculum and when during the instructional year that each academic content standard will be taught to the students.

After the standards-based assessment has been scored and the assessment result has been produced, the assessment data system generates the plurality of standards-based assessment reports 102 for use by Grade Level or Content Level Teams. The standards-based assessment reports 102 are produced at various levels to show the percentage of students that mastered each item or question and each academic content standard. It is noted that any particular academic content standard may be represented by more than one item or question so that item aggregations may be necessary for reporting mastery of the academic content standard. The plurality of reports 102 are generated so as to present the assessment result in a standards-based format which is very useful to educators. The plurality of reports 102 illustrate information including the percentage of students that mastered each item or question and each academic content standard. The plurality of reports 102 can be conveniently manipulated by the teachers using computer point and click methods and either viewed on a monitor screen, or printed out in different formats. One report format emphasizes data particular to each specific item or question while another format emphasizes the specific academic content standard of that subject matter, while a third format is directed to the detail of a specific item or question. It is noted that the computer point and click method is a computer assisted method to reconfigure a report. It is noted that the inventive method 100 also includes printing any of the above-recited reports on paper, and then placing the reports in a stack where each report can be reviewed as required. The computer point and click method is simply a report formatting technique and merely generates a new report or a different format of a report.

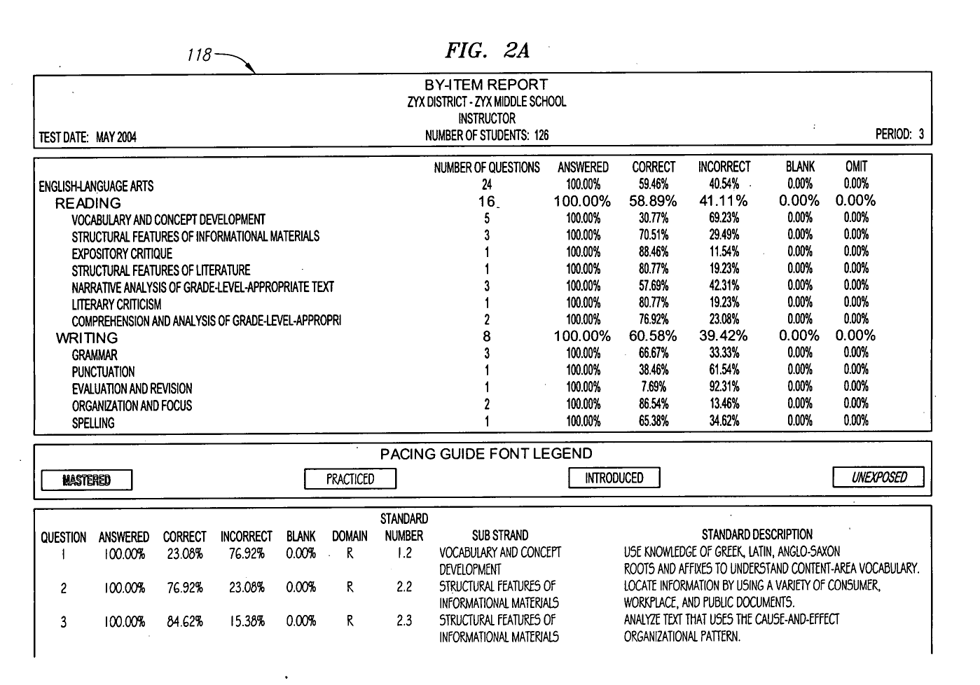

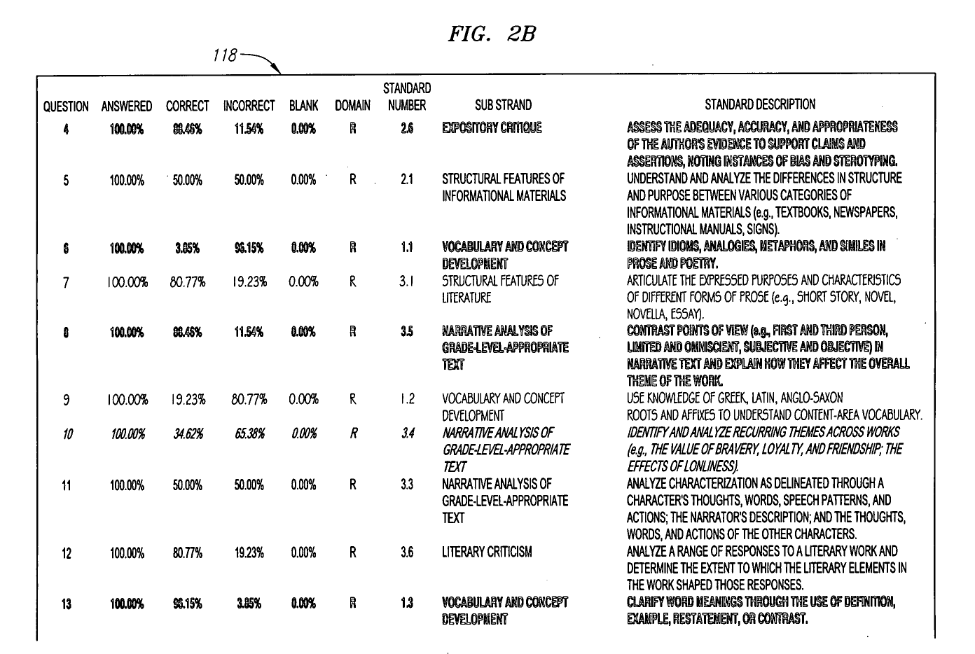

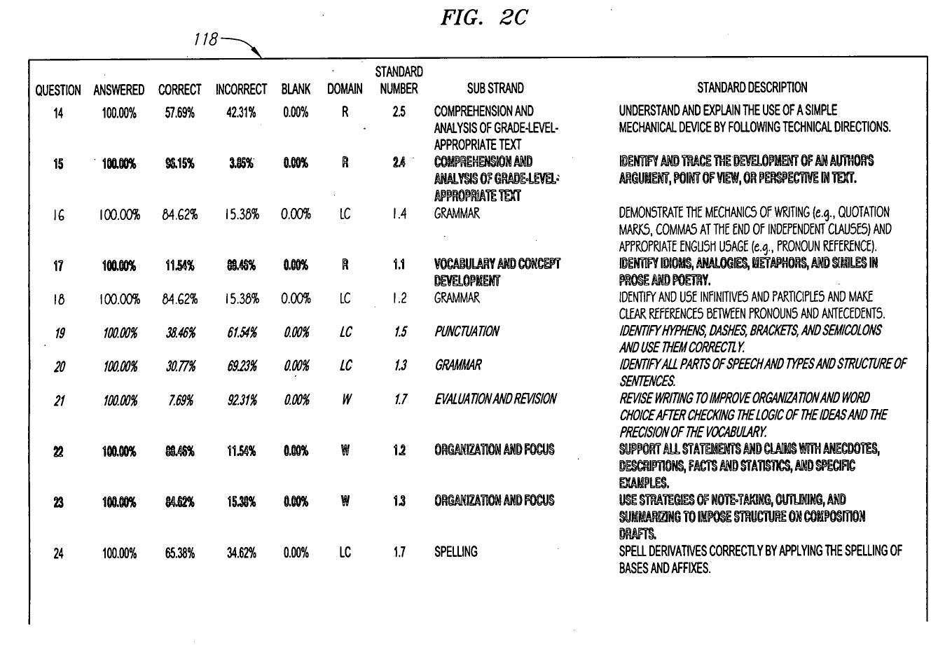

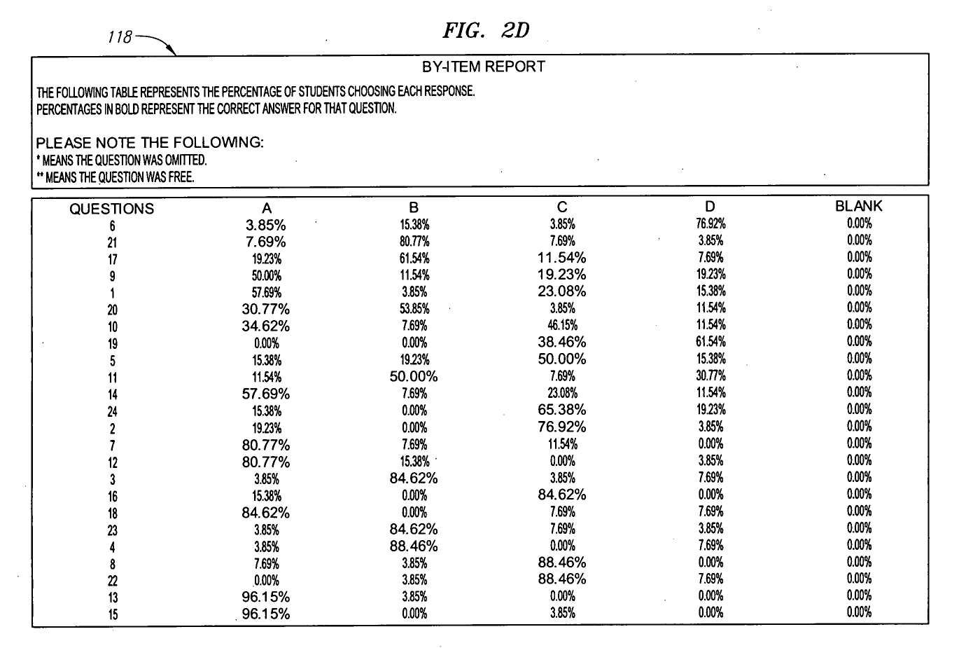

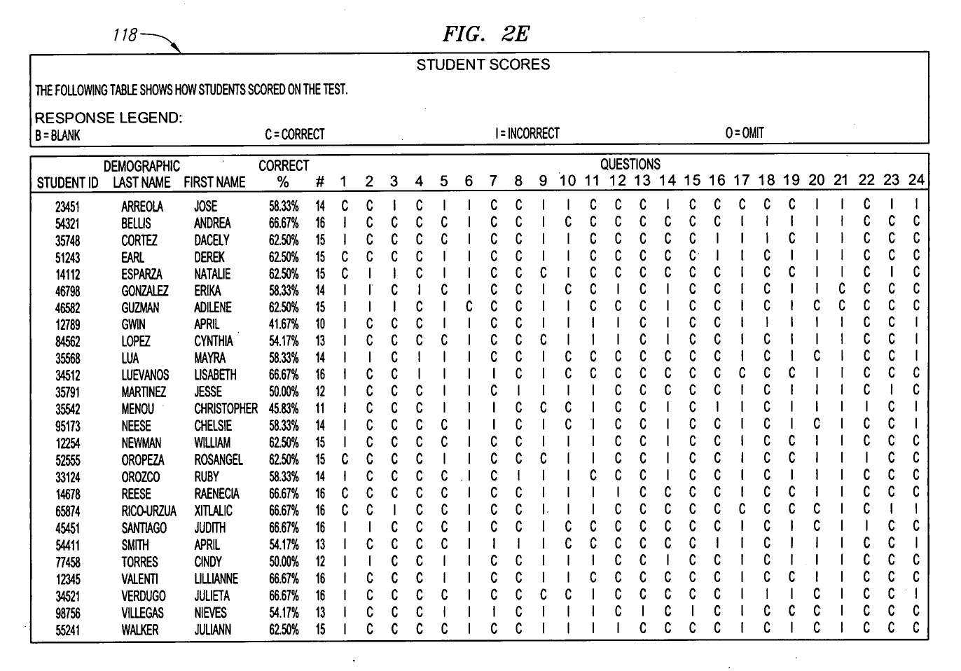

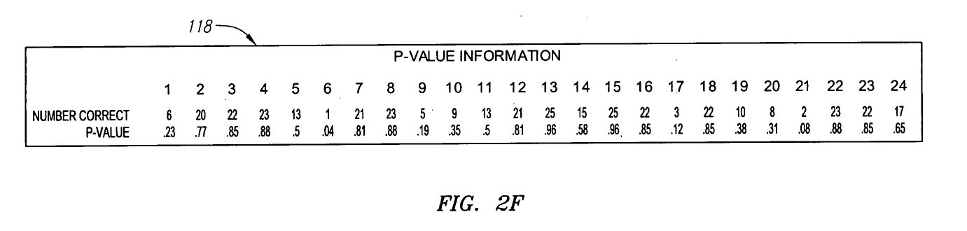

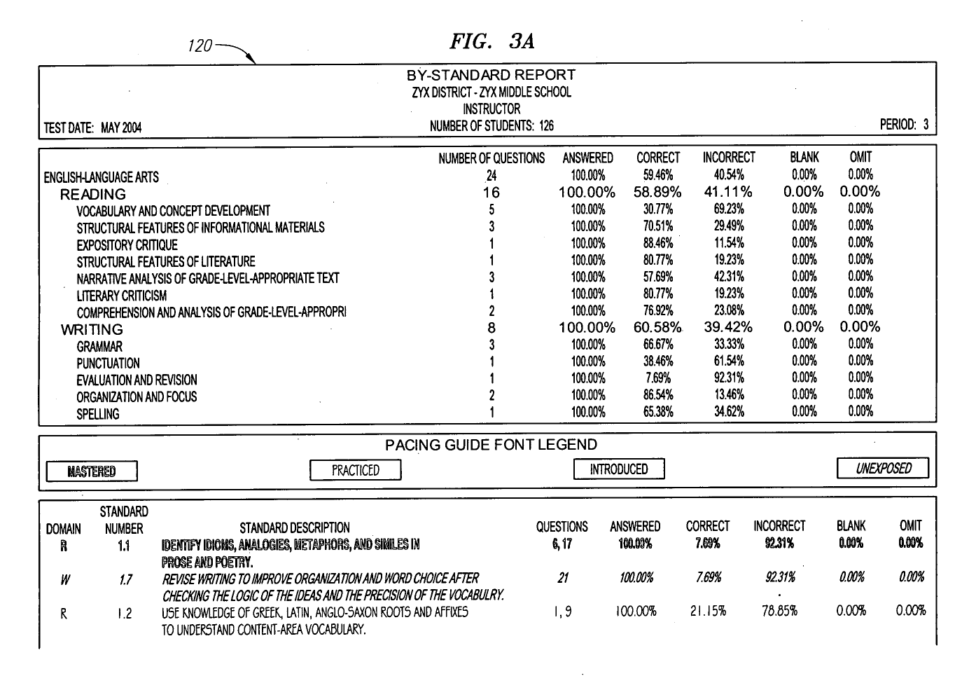

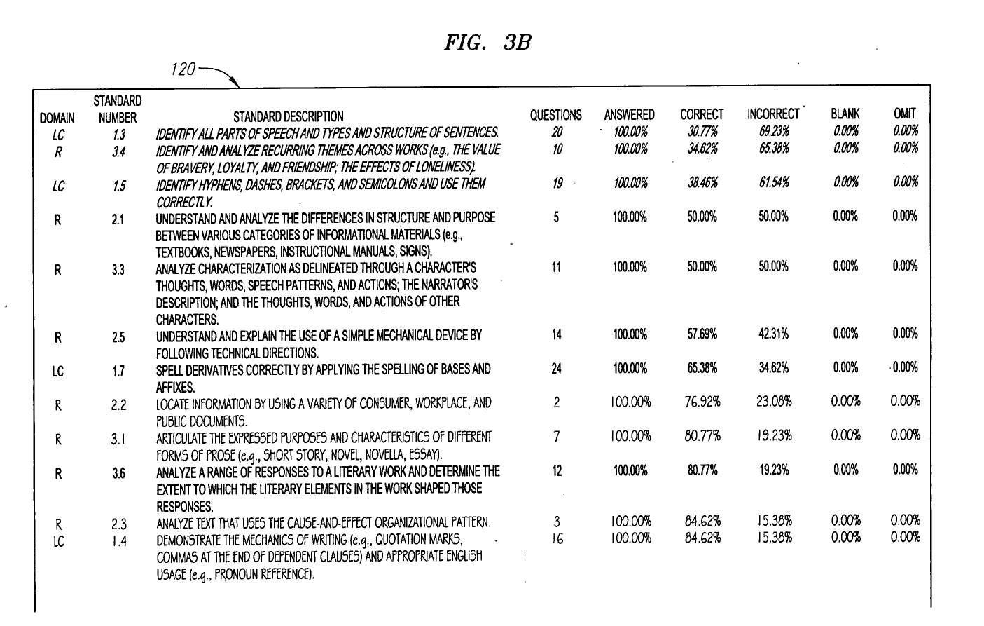

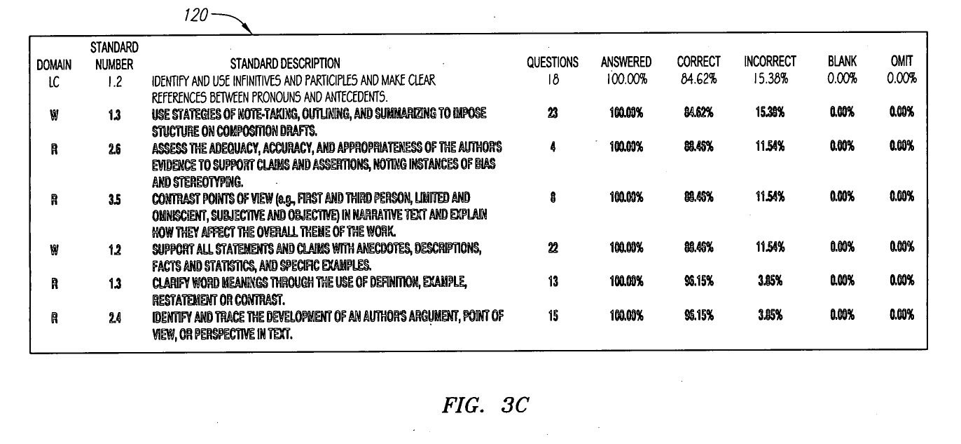

The generation of the plurality of standards-based assessment reports 102 by the assessment data system (after the administering of the standards-based assessment to the students) results in the step of generating a By-Item Report 118, a By-Standard Report 120 and the Item Detail Report 110, each shown in FIG. 1A. A specific example of the By-Item Report 118 is shown in FIGS. 2A-2F while a specific example of the By-Standard Report 120 is shown in FIGS. 3A-3C. The Item Detail Report 110 is clearly shown in FIG. 5. In general, a methodology is provided in the present invention for analyzing the plurality of reports 102 in an attempt to identify specific achievement problems suffered by the students. In addition to the method of listing the percentage of students that selected the correct answer and the percentage of students that selected an incorrect answer, the plurality of reports 102 that disclose assessment results By-Item or By-Standard may also show the pacing status, i.e., scheduling status. The pacing status is intended to illustrate the extent or degree to which a particular academic content standard, i.e., subject matter, has been presented to the students via classroom instruction in the current academic year. The pacing or scheduling status can be shown, for example, by dividing the reports 102 into a plurality of sections where each section separately indicates the extent to which the academic content standards have been presented to the students. Further, the extent to which each of the academic content standards has been presented to the students can be separately indicated by one of a plurality of different text fonts used for writing data in each separate section of the plurality of reports 102. Thus, the different text fonts in each section of the plurality of reports 102 immediately indicates the extend to which each academic content standard has been taught to students in the classroom.

Additionally, each separate text font in the plurality of reports 102 can represent a particular color where each separate color indicates the extent to which the particular academic content standard have been presented to the students in the classroom. For example, a first text font might be equated to the color red, a second text font equated to the color yellow, a third text font equated to the color green, and a fourth text font equated to the color blue. Each of these text fonts or equivalent colors would immediately visually indicate the degree or extent to which the particular academic content standard had been presented to the students or taught in the classroom.

In the alternative, the pacing status, i.e., scheduling status, can be illustrated by a background color printed directly onto the plurality of reports 102. For example, each separate section of each of the reports 102 can be illustrated in a different background color where each separate background color indicates the extent to which the academic content standards have been presented to the students in the classroom. A background color legend similar to the font legend shown in FIGS. 2A, 3A, and 4A could be printed directly onto each of the plurality of reports 102 so that the background color code of each section could be translated into the expected mastery level of the students who have experienced a specific exposure level in the classroom for the particular academic content standard. For example, the mastery background color code could include the (a) color red to indicate that the students have been introduced to, practiced and “mastered” the academic content standard, (b) color yellow to indicate that the students have been “introduced to and practiced” the academic content standard, (c) color green to indicate that the students have been “introduced once but have not practiced” the academic content standard, and (d) color blue to indicate that the students have “not been introduced” to the academic content standard. Thus, upon inspection of each of the plurality of reports 102, not only would the relevant percentages of the various measured variables be available, i.e., percentage of students that selected the correct answer for an item or question versus the percentage of students that selected an incorrect answer for the corresponding item or question, the pacing status or scheduling status would also be presented. Use of this information would assist in the step of analyzing the information presented on the plurality of reports 102. In fact, use of background colors directly on the plurality of reports 102 has been found to be particularly useful and effective by educators who have utilized the plurality of reports 102 for analysis purposes.

Other ways of exhibiting the pacing status, i.e., scheduling status, have also been determined. In addition to utilizing various text fonts or background color codes to indicate the extent of exposure that students have received in the instruction of a specific academic content standard, use of any alpha-numeric character or other symbol would also be suitable. For example, each of the plurality of reports 102, i.e., the By-Item Report 118, the By-Standard Report 120 and the Item Detail Report 110, could include an additional column in the data field. The additional column could be employed to print any alpha-numeric character or other symbol to indicate any of the four levels of the pacing status. For example, (1) a letter “M” could indicate that the academic content standard has been “mastered” by the students, (2) the letter “P” could indicate that the academic content standard has been “introduced and practiced” by the students, (3) the letter “I” could indicate that the academic content standard has been “introduced to but not practiced” by the students, and finally (4) the letter “N” could indicate that the academic content standard has “not been introduced” to the students. This method would function in a manner similar to the various text fonts or background color codes to indicate the pacing status or scheduling status on the plurality of reports 102.

We now turn our attention to the By-Item Report 118 of the plurality of reports 102 shown in detail in FIGS. 2A-2F. The By-Item Report 118 is produced by the assessment data system to report a standards-based assessment in a standards-based format by item or question. The By-Item Report 118 is displayed on a monitor (not shown) of the assessment data system and can be printed out if desired for convenient review and inspection. The data appearing on the By-Item Report 118 can be sorted by percentage correct or percentage incorrect in ascending or descending order. Further, the By-Item Report can be produced at any definable level, that is district-wide by grade level or content area, or school-wide by grade level or content area, teacher or class-wide, and for individual students. An abbreviated sample of student level data is shown in FIG. 2E reciting the percentage correct, total number of correct answers, and response to each item or question for each student. The pacing status or scheduling status is provided by the use of different text fonts in the various sections of the By-Item Report 118 where the different sections might coincide with the different items or questions. In the alternative, the pacing status could be provided by a background color code as described herein above. Additionally, difficulty and discrimination indexes, i.e., P-Value information, are furnished for each item in FIG. 2F.

In particular, the By-Item Report 118 shown in FIG. 1 and FIGS. 2A-2F lists the results of the standards-based assessment by the Item or question, by Domain, and by Strand for the entire grade level or content area assessed. The Items or questions are listed from Nos. 1-to-24 in FIGS. 2A-2C. The Domain is a term in the hierarchy of assessment standards and is defined as a collection of related academic content standards in a particular content area. For example, the Reading Domain and the Writing Domain are subdivisions of English/Language Arts. The Domains can be reduced down further into Strands which are a collection of even more closely related academic content standards such as, for example, the subject matter of Punctuation. Punctuation, in turn, can be reduced down further into Sub Strands, which themselves can be further reduced down to individual academic content standards. Not all of these subdivisions are required but Strands and Standards are.

The By-Item Report 118 includes the pacing status by utilizing the text font coding for each item in the different sections of the Report 118. For example, according to the Pacing Guide Font Legend on FIG. 2A, the font used for Items or Questions 1-3 indicates that the academic content standard has been introduced to and practiced by the students. However, the font used for Item or Question 4 indicates that the academic content standard has been mastered by the students, and the font used for Item or Question 5 indicates that the academic content standard has been introduced once but not practiced by the students. Further, the font used for Item or Question 10 indicates that the academic content standard has not been introduced to the students. Further, the By-Item Report 118 includes the percent correct, percent incorrect, and percent blank where the percentages refers to the percentage of students in the class as it relates to a particular item or question. Also included is the “P” value (i.e., the index of difficulty), the Domain, the Standard Number, the Sub Strand, and the Standard topic. The “P” value or index of difficulty shown in FIG. 2F is the generally accepted measure of difficulty of any item or question. A “P” value is computed by dividing the number of students selecting the correct answer by the total number of students attempting to answer the item or question. The “P” value is expressed as a percentage or decimal. Thus, an item or question with a “P” value of 1.00 is very easy since all students attempting the question answered the item correctly. Likewise, an item or question with a “P” value of 0.00 is so difficult that none of the students attempting the item or question answered it correctly. The Standard Number is a number assigned by the State Educational Agency or other political body to each academic content standard. Each of these features are clearly shown in FIGS. 2A-2C.

For illustration purposes, Item or Question #1 on the By-Item Report 118 shown on FIG. 2A recites the standard topic as “Use Knowledge of Greek, Latin, Anglo-Saxon Roots and Affixes to Understand Content-Area Vocabulary”. The Sub Strand is “Vocabulary and Concept Development”, the Domain is reading “R” as shown and the Standard number is 1.2. All students, i.e., 100%, attempted the question, no student left Question #1 blank, 23.08% of students answered Question #1 correctly while 76.92% of the students answered Question #1 incorrectly.

The next report in the plurality of reports 102 is the By-Standard Report 120 shown in FIG. 1 and in FIGS. 3A-3C. The By-Standard Report 120 is produced by the assessment data system upon command by a teacher to report a standards-based assessment by academic content standard (rather than by Item or question). The By-Standard Report 120 is necessary to properly evaluate the results of the Standards-Based Assessment. In a situation where there is more than one item or question per academic content standard, the assessment data system aggregates those items or questions under the appropriate standard heading. Additionally, the By-Standard Report 120 shows the pacing status of the particular academic content standard by the use of one of a plurality of different text fonts. Since the By-Standard Report 120 reports on a standards-based assessment by academic content standard, the By-Standard Report 120 can be divided into different sections much like the By-Item Report 118. The different sections of the By-Standard Report 120 can be presented in one of the plurality of different text fonts used for writing data in that particular section of the By-Standard Report 120. Thus, the different text fonts in each section of the By-Standard Report 120 immediately indicates the extend to which each academic content standard has been taught to students in the classroom.

In the alternative, the pacing status or scheduling status utilized in both the By-Item Report 118 and the By-Standard Report 120 could employ a background color coded system to indicate the degree or extent to which a particular academic content standard has been presented to the students by instruction in the current academic year. Thus, instead of the different sections of the By-Standard Report 120 being printed in a different text font as shown in FIGS. 3A-3C to indicate the pacing status, the different sections would be printed in a different background color to provide the same pacing status or scheduling status information. A background color legend printed directly onto the By-Item Report 118 and the By-Standard Report 120 could be used to translate the background color into the expected mastery level of the students for the particular academic content standard. For example, the (a) color red would indicate that the students have been introduced to, practiced and “mastered” the academic content standard, (b) color yellow would indicate that the students have been “introduced to and practiced” the academic content standard, (c) color green would indicate that the students have been “introduced once but have not practiced” the academic content standard, and (d) color blue would indicate that the students have “not been introduced” to the academic content standard. Thus, upon inspection of the By-Item Report 118 or the By-Standard Report 120, not only would the relevant percentages of the various measured variables be available but also the pacing status or scheduling status would be presented.

The By-Standard Report 120 lists the results of the standards-based assessment by academic content standard, by Domain, and by Strand for the entire grade level or content area as shown in FIGS. 3A-3C. The By-Standards Report 120 also clearly illustrates the pacing status using different text fonts, percent correct, percent incorrect, and percent blank where the percentages refer to the percentage of students in the class as it relates to a particular academic content standard, the Domain, the standard number, the Sub Strand, and the standard topic. Each of these measured variables are defined in the same manner and have the same meaning as previously indicated in the By-Item Report 118. Each of these measured variables are clearly shown in FIGS. 3A-3C. However, Domain, which is a term in the hierarchy of assessment standards and is defined as a collection of related academic content standards in a particular content area, is used primarily to reduce the English/Language Arts academic content area into reading and writing. The Strand is a related collection of academic content standards, i.e., number sense for mathematics or reading comprehension for English/Language Arts. Certain Strands are defined by the State Education Agency or other political body but any school can define a Strand that they believe is significant by stipulating which academic content standards belong to the Strand. The Sub Strand is an option used to reduce a Strand into a collection of standards fewer in number than a Strand.

Additionally, the items or questions that are used to test the students knowledge in the corresponding academic content standard are listed for each standard number. The By-Standard Report 120 is produced on a computer screen of the assessment data system and can be printed out for convenient review and inspection. The By-Standard Report 120 can be sorted by the assessment data system by the percent correct or percent incorrect measured variables in either ascending or descending order. The difference between the By-Item Report 118 and the By-Standard Report 120 is that the By-Standard Report 120 aggregates assessment results data for items that measure the same academic content standard. Therefore, a displayed academic content standard on the By-Standard Report 120 may comprise one or more items and the percentages shown are aggregations from all applicable item results.

For illustration purposes, academic content standard 1.1 of the By-Standard Report 120 shown in FIG. 3A recites the academic content standard topic as “Identify Idioms, Analogies, Metaphors, and Similes in Prose and Poetry”. Thus, the Domain is directed to reading “R” as shown. Questions 6 and 17 are identified as questions directed to this academic content standard 1.1. The entire class attempted these questions, i.e., 100%, where 7.69% of the class answered these questions correctly while 92.31% of the class answered these questions incorrectly. No student left the answers blank or omitted the questions.

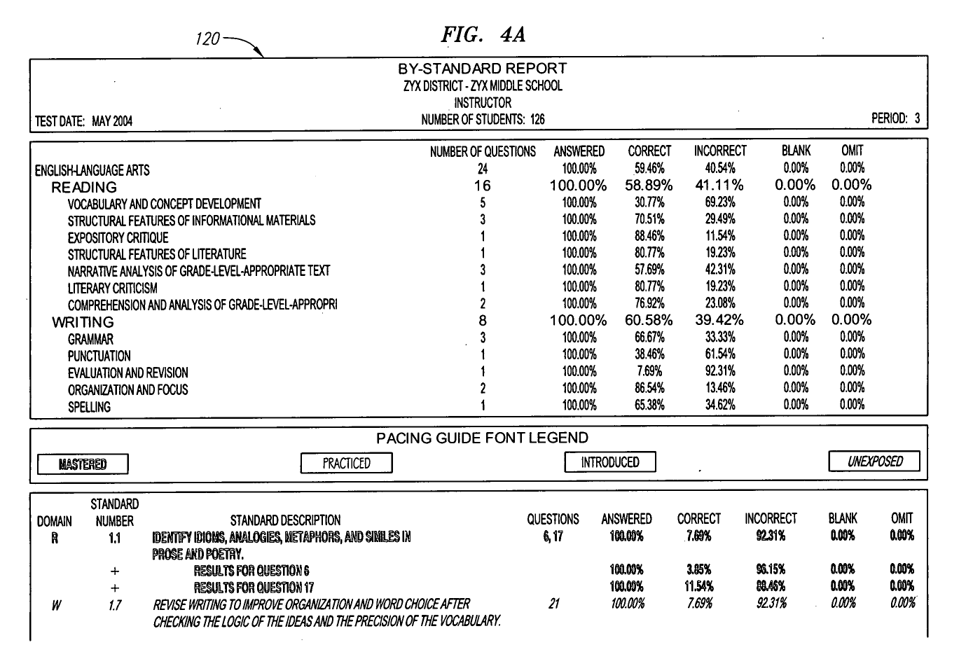

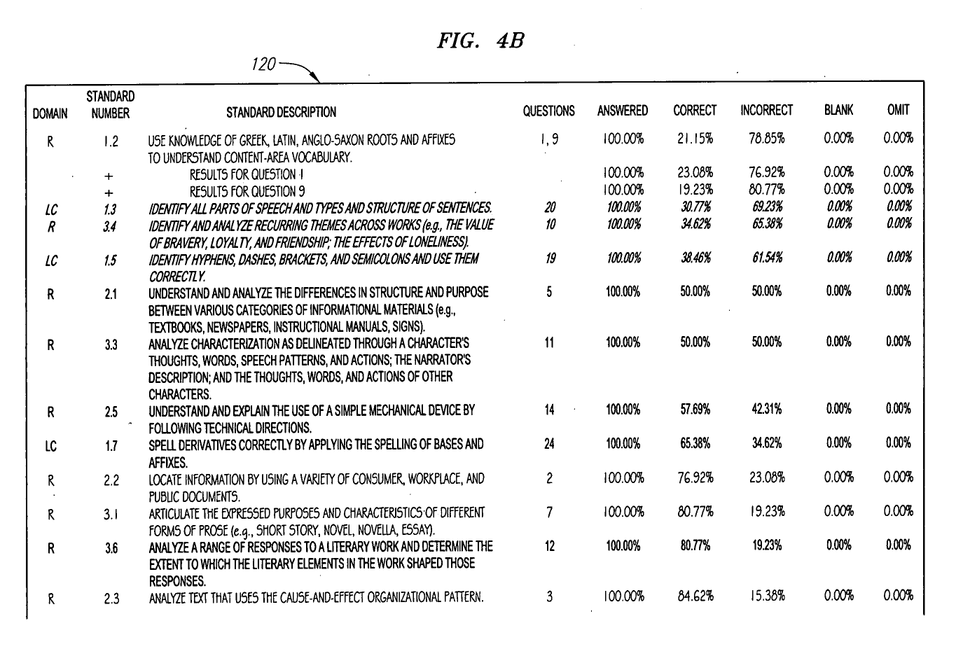

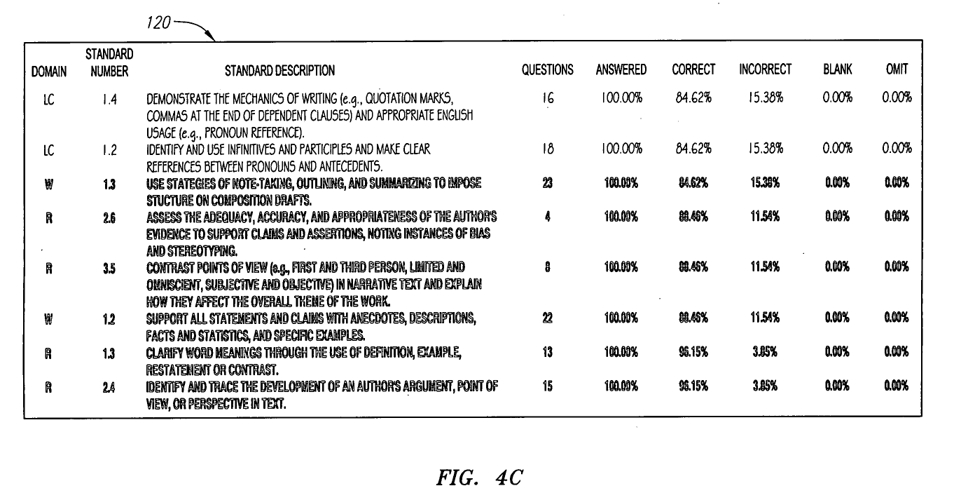

A duplicate By-Standard Report 120 is shown in FIGS. 4A-4C except that a teacher or educator has employed the point and click technique (associated with the assessment data system) to select an academic content standard of interest. This is the step of Expanding the By-Standard Report 122 as shown in FIG. 1A. In the illustrated case, the point and click technique has been applied to academic content standards 1.1 and 1.2 in FIG. 3A. The result is shown in FIGS. 4A and 4B wherein the assessment data system has automatically expanded the display of the academic content standards 1.1 and 1.2. The expanded display exhibits each item or question in that standards-based assessment that measures that particular academic content standard. In the illustrated case, academic content standard 1.1 exhibits the results of Questions 6 and 17 as shown in FIG. 4A while academic content standard 1.2 exhibits the results of Questions 1 and 9 as shown in FIG. 4B.

The final report of the plurality of standards-based assessment reports 102 is the Item Detail Report 110 clearly shown on FIG. 5. The Item Detail Report 110 represents the report format that the assessment data system will generate if the point and click technique is applied to an item or question within a display of a particular academic content standard. The Item Detail Report 110 explains the item or question of interest to include the following. The stem of the item, i.e., the stimulus portion of an item or question that solicits a response from the student, is set forth. In the example in FIG. 5, where the topic is “Word Analysis”, academic content standard 1.2 sets forth the stem of Question #9 stating: From your knowledge of Greek roots and affixes, “bibliophile” is most likely to mean? Also exhibited in FIG. 5 are the Distractors, i.e., the plurality of incorrect responses, and the correct answer. In the example of Question #9, Answers A, B and D are distractors while answer C is the correct answer. Next, the percentage of students that chose each of the Distractors is disclosed as follows: 50% of the students chose Answer A; 12% of the students chose Answer B; and 19% of the students chose Answer D. The correct Answer C was chosen by 19% of the students. Next, the cognitive rationale for each of the Distractor Answers A, B and D is set forth to explain why the students most likely selected these wrong answers. The Rationale is designed into the standards-based assessment during the question design phase which satisfies the compliancy requirement of the method 100. Finally, the instructional context, the location by chapters and pages, where and when the particular academic content standard is taught in the instructional program in the relevant school district is shown. The Item Detail Report 110 is necessary to properly evaluate the results of the standards-based assessment.

The next step in the method 100 is the Determination of Weak Standards 124 as is shown in the flowchart of FIG. 1A. The reporting of the standards-based assessment, i.e., after the assessment or test has been administered to the students, is completed for the following levels. Initially, the assessment results are reported to the school district by grade level or by content area as appropriate, then to the school by grade level or by content area for non-grade specific tests, by teacher, and then by individual student. When a school receives the results for an administration of a standards-based assessment or test, the method 100 immediately requires the meeting of the grade level teams or content level teams with each grade level team receiving the grade level or content level reports. A grade level team is defined as a group of teachers that evaluate assessment or test results data from the perspective of a particular grade level while a content level team is defined as a group of teachers that evaluate assessment or test results data from the perspective of specific subject matter such as algebra or English.

In the academic content areas of secondary schools where the academic content standards are not organized by grade level, the appropriate forum is the content level team, i.e., the teachers or educators that teach the particular content area (i.e., subject matter) or the academic Department Level, if appropriate. Levels of reports lower than grade level or content area are not normally distributed until the grade level team or content level team has finished analyzing the grade level or content level reports. If the grade level team or content level team is using a computer monitor of the assessment data system to view the plurality of standards-based assessment reports 102, then the team members would agree not to view lower level reports until after the grade level or content level reports are analyzed. This agreement ensures that the teachers of the respective teams initially concentrate on the larger group analysis. Once the method 100 moves to any lower level of analysis, then the lower level reports are distributed and teachers on the respective teams can concentrate on the assessment data directed to their own classrooms.

In the step of Determination of Weak Standards 124, the entire grade level team or content level team studies the By-Item Report 118 and the By-Standard Report 120. The respective team also has a copy of the standards-based assessment or test that the plurality of reports 102 represent (which is generated automatically by the assessment data system). For the By-Item Report 118, the appropriate team scans the Report 118 to look for items or questions that appear “out of place”, i.e., have high rates of incorrect responses that are inconsistent with the corresponding pacing status (shown by different text fonts) such as “Mastered” or “Practiced”. In this step, the respective team members also look for “P” values (i.e., index of difficulty) that seem overly easy or difficult for the assessment or test. The information obtained in this step of determining weak standards 124 is useful in the next step.

The methodology of analyzing the plurality of standards-based assessment reports 102 provided by the present inventive method 100 enables the different data to be compared. For example, suppose that in the By-Item Report 118, the percentage of students who selected the incorrect answer in a particular section of the Report 118 is very high. Simultaneously, suppose that the text font used for the writing in the same section of the By-Item Report 118 (or alternately the background color code used for the same section of the By-Item Report 118) indicates that the subject matter should be “mastered” or “well practiced” based upon the pacing status, i.e., scheduling status. This inconsistency exposed by this analysis indicates that a deficiency exists with this academic content standard. Typically, this academic content standard is selected for further review and analysis and the items or questions associated with this academic content standard will also be reviewed. The specific items or questions associated with the academic content standard can be reviewed on the Item Detail Report 110 that addresses the detail of a specific item or question. The Item Detail Report 110 includes the documented cognitive rationale that explains why a student might select a particular incorrect answer via a rationale response analysis. Academic content standards and the items or questions contained therein that are selected for additional review and analysis are referred to as “weak standards” and “weak items”, i.e., particular academic content standards in which the percentage of incorrect answers to the items or questions presented to test the students knowledge in the relevant subject matter is high. This assumes that the students have had adequate exposure to the subject matter to be able to answer the items or questions correctly. This step of Determination of Weak Standards 124 in the inventive method 100 enables the detection of student achievement problems.

For the By-Standard Report 120 in the step of Determination of Weak Standards 124, the grade level team or content level team will normally sort the By-Standard Report 120 from the most incorrect to the least correct academic content standard. In particular, the grade level team sorts the By-Standards Report 120 in descending order by percent incorrect. In reality, the assessment data system accomplishes this sorting function automatically once the point and click technique is applied to the top of the percent incorrect column of the By-Standard Report 120. The grade level team begins its investigation with the most missed academic content standard and progresses toward the least missed academic content standards. The By-Standard Reports 120 can also be sorted or filtered by percent correct, by degree of coverage, i.e., pacing status, by language fluency, socio-economic status, ethnicity, students with disabilities, or any appropriate field to include special programs. In a “perfect” report, one would expect the “unexposed” standards to be at the top of the By-Standard Report 120 (since they have not yet been taught) followed by the “introduced” standards, the “practiced” standards, and then the “mastered” standards. Rarely is this “perfect” condition the result obtained in a standards-based assessment. In the By-Standard Report 120 shown in FIG. 3A, the grade level team is immediately alerted to the fact that an academic content standard (i.e., Standard 1.1) that exhibits a text font indicating that the subject matter has been “mastered” by the students is actually the most missed academic content standard. Similarly, an academic content standard (i.e., Standard 1.2) that exhibits a text font indicating that the subject matter has been “introduced to and practiced” by the students is also near the top of the By-Standard Report 120 (where one would expect to find text fonts indicating that the students have been “unexposed” to the subject matter).

The team will then begin the study of each academic content standard in turn starting from the top of the By-Standard Report 120, i.e., starting from the most missed academic content standards. The pacing status (indicated by the different text fonts in each section of the By-Standard Report 120) combined with the “percentage incorrect” data enables the grade level team to quickly focus on the critical academic content standards. As each academic content standard is inspected, the grade level team will address each item and will employ the rationale or logical thought process that is summarized in the accompanying flowchart beginning with step 126 of method 100 to determine if the standard should be labeled “weak” for the purposes of analysis.

The next step in the method 100 as shown in the flowchart of FIG. 1A is the step 126 setting forth the question “Has The Content Standard Been Adequately Covered During The Instructional Year To The Point That The Percent Incorrect Is Alarming?” A follow-up question might ask whether the academic content standard has been taught yet? If the academic content standard has not yet been taught, should the assessment results be ignored or should the assessment results be addressed? If the academic content standard has been taught, to what degree or extent is the coverage and what results should be expected from the students exposed to the standards-based assessment? This portion of the method 100 is aided by the pacing status which addresses the degree or extent of coverage of the academic content standard. After due consideration, should the assessment results be addressed? It is noted that an academic content standard chosen for analysis by the grade level team or content level team is labeled a “weak” standard. For example, if the most missed academic content standards exhibit a pacing status text font indicating that the students have been “unexposed” to the subject matter, then those academic content standards would understandably be the most missed standards in the standards-based assessment. The same rationale might also apply to an academic content standard that was recently “introduced to the students but not practiced”.

If the answer to the question of step 126, i.e., “Has the academic content standard been adequately covered during the instructional year to the point that the percent incorrect is alarming?”, is no, then the next step 128 asks the question, “Does the grade level team want to analyze the academic content standard further anyway?” If the answer is no, the grade level team then advances to the next academic content standard, i.e., Go to Next Standard 130. If the answer is yes, i.e., the grade level team decides to analyze the academic content standard further anyway, then the method advances to a step 132. Likewise, if the answer to the question to step 126, “Has the academic content standard been adequately covered during the instructional year to the point that the percent incorrect is alarming?”, is yes, the method also advances to step 132.

The next step in the method 100 is to Determine the Weak Items For The Weak Standards 132 as shown on FIG. 1B. Continuing with the By-Standard Report 120 shown in FIGS. 3A-3C, the academic content standard of interest, i.e., Standards 1.1 and 1.2, can be expanded by applying the point and client technique to the monitor screen of the assessment data system to obtain the By-Standard Report 120 shown in FIGS. 4A-4C. Upon completion of the expansion of the academic content standards 1.1 and 1.2, all the items or questions that measure each standard are shown. Academic content standard 1.1 is measured by items or questions 6 and 17 while academic content standard 1.2 is measured by items or questions 1 and 9. Each of these items or questions may now be analyzed to determine the weak items for the weak standards in step 132 starting with the item or question that is most often missed by the students. The grade level team considers each academic content standard that was considered weak in step 124 or was chosen to be analyzed anyway in step 128 and in need of further investigation. The grade level team simply applies the point and click technique onto the candidates for weak academic content standards 1.1 and 1.2, and the assessment data system is commanded to expand those standards to reveal the individual items that were used to measure those particular standards. By studying the “percent incorrect” for these items, the grade level team can determine which items played a part in causing that particular academic content standard to be classified as “weak”. Those particular items or questions are also labeled “weak” and will require further analysis. For example, note that item or question 9 which measures academic content standard 1.2 recites 80.77% incorrect while the pacing status text font indicates that question 9 has been “introduced to and practiced” by the students. This information clearly identifies a deficiency with respect to the subject matter of question 9.

The next step is to Determine Why Students Incorrectly Answered An Assessment Item By Using Response Rationale Analysis 134. The grade level or content level team surveys each “weak” item or question measuring a “weak” academic content standard in an attempt to determine why students incorrectly answered that particular item or question (and by association, Why the students did not receive as high a score on that particular academic content standard as the team thought appropriate). The technique employed for this process is entitled Wrong Answer Analysis which is an analysis based upon student response rationale. If the team uses the point and click technique on a particular item or question to be analyzed, an Item Detail Report 110 will be produced for that item or question. For example, an Item Detail Report 110 for item or question #9 (which is a “weak” item measuring “weak” academic content standard 1.2) is shown in FIG. 5. The Item Detail Report 110 lists the academic content standard measured, the stem of the item, the correct response, the Distractors, the percentage of students choosing the correct answer and each Distractor, the rationale of each Distractor, and the location in the instructional program where the content standard was taught. The team studies the “% Responding” column in order to determine the predominant response chosen by the students. Then the team studies the corresponding rationale for the most predominantly chosen response. In the example of item or question #9, the cognitive rationale listed in the Item Detail Report 110 explains the most likely cognitive process that a student would use to choose that particular incorrect response, i.e., Distractor Answer A. By studying the cognitive rationale, the team can make logical inferences as to why the students answered item #9 incorrectly. Depending upon the percentage distribution, more than one student response may need to be analyzed suggesting that there may be multiple reasons why the students selected the incorrect answer.

The next step in the method 100 is to Determine the Instructional Context of the Weak Content Standards 136 as shown on the flowchart in FIG. 1B. In this step 136, the grade level team or content level team studies the instructional materials to determine where, when and how the “weak” academic content standard was taught in the current instructional program. This step 136 in the method 100 provides guidelines for placing the academic content standards in an instructional context for determining when the content standards were addressed during the academic year. This step 136 is aided by the Item Detail Report 110 provided by the assessment data system which specifies the specific instructional program used by the school district and the place in that instructional program where the particular academic content standard is taught. By utilizing the “Why” logic from step 134 (i.e., Determine Why Students Incorrectly Answered An Assessment Item By Using Response Rationale Analysis 134) and the Instructional Context from step 136 (i.e., Determine the Instructional Context of the Weak Content Standards 136), the inventive method 100 provides guidelines to help the team determine not only the cognitive disconnect of the students incorrectly answering the item or question but also how and where the disconnect might have occurred during classroom instruction.

Based on the parameters of the instructional context and the amount of coverage afforded the students thus far (that is, the pacing status text fonts appearing on the plurality of standards-based assessment reports 102), the issue is whether the level of student mastery of the academic content standard is acceptable, or does the situation call for some remedial action. If remedial action is required, the next step in the method 100 is to Design an Intervention Strategy For Improving Student Performance 138 as shown on the flowchart in FIG. 1B. In step 138, the grade level team or content level team uses the information gained from the “Why” logic of step 134 and the Instructional Context of step 136 to design an intervention strategy for those students that incorrectly answered the item or question of interest. With the “Why” logic of step 134 and the Instructional Context of step 136 in mind, the team drafts a plan to address the student achievement problems. Initially, the team focuses on the items or questions of the standards-based assessment or test that addressed that particular academic content standard with particular attention given to the percentage of students that selected the correct answer and the percentage of students that chose a Distractor (i.e., an incorrect answer). This information is available on the Item Detail Report 110. Next, determine the most prevalently chosen Distractor (i.e., incorrect or wrong answer) and study the rationale for that Distractor which can be found on the Item Detail Report 110. Using the rationale for the most prevalently chosen Distractor (i.e., incorrect answer) in light of the instructional context (discussed above with respect to step 136), determine what intervention strategy needs to be invoked to counter the prevalent cognitive disconnect(s) that resulted in the student choosing the wrong answer.

Once these plurality of parameters {i.e., “Why” logic of step 134 (which examines the rationale associated with the most commonly chosen Distractor to determine the most prevalent cognitive disconnects), the pacing status text fonts, and the Instructional Context of step 136} are identified and set forth, an intervention strategy can be developed for improving the performance of the students. In the case of a simple reversal of terminology or a misunderstood concept by the student (as set forth in item or question #9 of the Item Detail Report 110 of FIG. 5), the intervention strategy might be as simple as to review the Greek language root affixes, particularly “phile”, and how they are employed in English to influence the meaning of a compound word. Cognitive disconnects of a more complex nature will require more elaborate intervention strategies. The complexity of the intervention strategy is dependent upon the severity of the cognitive disconnect that the student has acquired.

The next step in the method 100 is to Implement the Intervention Strategy 140 as shown on the flowchart in FIG. 1B. In Step 140, once a plan for invoking the intervention strategy is made, the planned intervention is actually implemented. The grade level or content level team then determines whether there is justification for completing a similar analysis on the next most often chosen Distractor, i.e., incorrect answer. In most cases, the students will predominately choose one of the wrong answers over the others resulting in trivial percentages of selections of the other wrong answers. In some cases, however, there may be several wrong answers with significant selection percentages. This situation will most often occur when the students are “unexposed” to the academic content standard, i.e., the students have not been taught the subject matter, or there is significant misunderstanding among the students regarding the particular academic content standard.

The next step in the method 100 is to Re-Measure the Content Standard 142 also shown on the flowchart in FIG. 1B. In step 142, the grade level team or content level team begins the process anew by re-measuring the “weak” academic content standards. Ideally, new or different items or questions would be utilized to measure the same academic content standards. In essence, the method 100 is re-started. The grade level or content level team will continue to identify “weak” standards as recited in step 124, identifying the instructional context as recited in step 136, and then developing an intervention strategy as recited in step 138 based upon the cognitive rationale of the most prevalently chosen Distractors, i.e., incorrect answers, until one of the following occurs: (1) the team determines that they have progressed far enough down the “mastery” continuum so that the next academic content standards to be considered are adequately mastered based upon the amount of instruction that has taken place so far in the academic year, i.e., pacing status; (2) the team believes that they have achieved “saturation” with regard to the amount of intervention that will have to be invoked; or (3) the team has reviewed and amended all of the academic content standards.

The next step in the method 100 is to Determine The Next Level of Process Analysis 144 as shown on the flowchart in FIG. 1B. In step 144, the grade level team or content level team decide whether to re-initiate the method 100 at continuously lower levels, i.e., at teacher level or individual student level. The first iteration of the method 100 is always executed at the grade team level or the content team level. Subsequent iterations of the method 100 intended to identify “weak” standards and “weak” items should continue at the team level. However, once the first set of team level interventions are determined and an execution plan is drafted, the teachers or team members may decide to apply the analytical method 100 at the classroom (or teacher) level. The “Why” logic introduced at step 134 might be somewhat different when the analyzed group is reduced to the students in a single teacher's scope of influence. After the teacher has performed the analytical method 100 at the teacher level to the teacher's satisfaction, then the next step is to perform the analysis at the individual student level. Note that the correct sequence of analysis levels starts at the grade level or content level and moves to lower and lower levels, i.e., teacher and then individual student level. By using this method 100, the larger issues are addressed before the smaller issues. The grade level or content level analysis addresses primarily the effect of the instructional program (materials, teaching and processes) on student learning of the academic content standards. Teacher level analysis will emphasize the effect of the materials, teaching and processes but will emphasize the teacher's approach. The analysis at the individual student level will target the specific student's achievement problems with learning. All levels of analysis are important. Funneling the effort from the highest level to the lowest level provides the advantage of taking care of the largest number of students first, thereby presenting a smaller and smaller target for remediation as the process continues.

The next step in the method 100 is to determine What Is The Selected Level Of Process Analysis For The Next Iteration 146, i.e., Team, Teacher, Individual Student or Special Grouping? The grade level team or the content level team will decide whether they will continue to apply subsequent iterations of the method 100 intended to identify “weak” standards and “weak” items at (1) the grade level or content level, (2) the teacher level, (3) individual student level, or (4) a special grouping level such as non-English speaking groups, students with disabilities groups, etc. For the selection of further iterations at the grade level or content level (team level), the method 100 returns to the step of Formulate and Administer Standards-Based Assessment 106 via the step of Return to Beginning of Process 148 on a line 150. For the selection of further iterations at the teacher level, individual student level or special grouping level, the method 100 returns to the step of Formulate and Administer Standards-Based Assessment 106 via the step of Return to Beginning of Process and Specify Appropriate Level of Data 152 on the line 150.

While the present invention is described herein with reference to illustrative embodiments for particular applications, it should be understood that the invention is not limited thereto. For example, while the method 100 is described in terms of evaluating testing directed to one or more students at the classroom, school, district or even state level, it is within the scope of the invention to utilize the method 100 in conjunction with the evaluation and/or instruction of a single student, as for example in a private learning center or home schooling context. In that case, the method 100 would be modified to eliminate the team, classroom, teacher evaluation portions of the method 100 and concentrate on the individual student. Those having ordinary skill in the art and access to the teachings provided herein will recognize additional modifications, applications and embodiments within the scope thereof and additional fields in which the present invention would be of significant utility.

It is therefore intended by the appended claims to cover any and all such modifications, applications and embodiments within the scope of the present invention.

Accordingly,

What is claimed is:

1. A method for analyzing standards-based assessment data, said method comprising the steps of:
formulating a standards-based assessment of a plurality of academic content standards for administering to a plurality of students, said assessment based upon an existing set of academic content standards;
generating a plurality of reports from administering said assessment for presenting at least one assessment result in a standards-based format;
analyzing said reports for identifying achievement problems of said students; and
developing an intervention strategy for improving the performance of said students.

2. The method of claim 1 further including the step of identifying an instructional context of said content standards.

3. The method of claim 1 further including the step of providing a plurality of sections in said reports, each section separately indicating the extent to which said content standards have been presented to said students.

4. The method of claim 3 wherein the extent to which each of said content standards has been presented to said students is separately indicated by one of a plurality of different text fonts in each section of said reports.

5. The method of claim 4 wherein a first text font appearing in said reports represents a first color indicating that said content standards have been mastered by said students.

6. The method of claim 4 wherein a second text font appearing in said reports represents a second color indicating that said content standards have been introduced and practiced by said students.

7. The method of claim 4 wherein a third text font appearing in said reports represents a third color indicating that said content standards have been introduced but not practiced by said students.

8. The method of claim 4 wherein a fourth text font appearing in said reports represents a fourth color indicating that said content standards have not been introduced to said students.

9. The method of claim 3 wherein the extent to which each of said content standards has been presented to said students is separately indicated by one of a plurality of different background colors in each section of said reports.

10. The method of claim 9 wherein a first background color appearing in said reports indicates that said content standards have been mastered by said students.

11. The method of claim 9 wherein a second background color appearing in said reports indicates that said content standards have been introduced and practiced by said students.

12. The method of claim 9 wherein a third background color appearing in said reports indicates that said content standards have been introduced but not practiced by said students.

13. The method of claim 9 wherein a fourth background color appearing in said reports indicates that said content standards have not been introduced to said students.

14. The method of claim 1 further including the step of providing a standards-based item bank and a demographic and test data input.

15. The method of claim 1 further including the step of creating and storing a rationale for each of a plurality of incorrect responses associated with each of a plurality of test items of said standards-based assessment.

16. The method of claim 1 further including the step of scoring said standards-based assessment for providing said assessment result.

17. The method of claim 1 wherein said step of generating a plurality of reports further includes the step of providing a By-Item Report.

18. The method of claim 1 wherein said step of generating a plurality of reports further includes the step of providing a By-Standard Report.

19. The method of claim 1 wherein said step of generating a plurality of reports further includes the step of providing an Item Detail Report.

20. The method of claim 2 wherein said step of identifying the instructional context of said content standards further includes the step of determining if said content standards have been adequately presented to said students during the instructional year.

21. A method for analyzing standards-based assessment data, said method comprising the steps of:
formulating a standards-based assessment of a plurality of academic content standards for administering to a plurality of students, said assessment based upon an existing set of academic content standards;
generating a plurality of reports from administering said assessment for presenting at least one assessment result in a standards-based format, said reports providing a plurality of sections each separately indicating the extent to which said content standards have been presented to said students;
analyzing said reports for identifying achievement problems of said students; and
developing an intervention strategy for improving the performance of said students.

22. A method for analyzing standards-based assessment data, said method comprising the steps of:
formulating a standards-based assessment of a plurality of academic content standards and administering said assessment to a plurality of students, said assessment based upon an existing set of academic content standards;
scoring said standards-based assessment for providing at least one assessment result;
generating a plurality of reports for presenting said assessment result in a standards-based format;
analyzing said reports for identifying achievement problems of said students; and
developing an intervention strategy for improving the performance of said students.

23. The method of claim 22 further including the step of providing a plurality of sections in said reports, each section separately indicating the extent to which said content standards have been presented to said students.

24. A method for analyzing standards-based assessment data, said method comprising the steps of:
selecting and administering a standards-based assessment of a plurality of academic content standards to a plurality of students, said assessment based upon an existing set of academic content standards;
analyzing a result of said assessment using a rationale response analysis for detecting achievement problems of said students and for assisting in identifying why said students responded incorrectly during said assessment;
placing said content standards in an instructional context for determining when said content standards were presented to said students; and
developing an intervention strategy for improving the performance of said students.

25. The method of claim 24 further including the step of providing a plurality of sections in said result of said assessment, each section separately indicating the extent to which said content standards have been presented to said students.

26. The method of claim 24 wherein said step of identifying why said students responded incorrectly during said assessment further includes the step of studying a cognitive rationale of the most predominate student response.

27. A method for analyzing standards-based assessment data, said method comprising the steps of:
formulating a standards-based assessment of a plurality of academic content standards for administering to a plurality of students, said assessment based upon an existing set of academic content standards;
generating a plurality of reports from administering said assessment for presenting at least one assessment result in a standards-based format;
providing a methodology for analyzing said reports for identifying achievement problems of said students; and
setting forth a plurality of parameters for developing an intervention strategy for improving the performance of said students.

28. The method of claim 27 further including the step of providing guidelines for identifying an instructional context of said content standards.

29. The method of claim 27 further including the step of providing a plurality of sections in said reports, each section separately indicating the extent to which said content standards have been presented to said students.

30. The method of claim 29 wherein the extent to which each of said content standards has been presented to said students is separately indicated by one of a plurality of different text fonts in each section of said reports.

31. The method of claim 30 wherein a first text font appearing in said reports represents a first color indicating that said content standards have been mastered by said students.

32. The method of claim 30 wherein a second text font appearing in said reports represents a second color indicating that said content standards have been introduced and practiced by said students.

33. The method of claim 30 wherein a third text font appearing in said reports represents a third color indicating that said content standards have been introduced but not practiced by said students.

34. The method of claim 30 wherein a fourth text font appearing in said reports represents a fourth color indicating that said content standards have not been introduced to said students.

35. The method of claim 29 wherein the extent to which each of said content standards has been presented to said students is separately indicated by one of a plurality of different background colors in each section of said reports.

36. The method of claim 35 wherein a first background color appearing in said reports indicates that said content standards have been mastered by said students.

37. The method of claim 35 wherein a second background color appearing in said reports indicates that said content standards have been introduced and practiced by said students.

38. The method of claim 35 wherein a third background color appearing in said reports indicates that said content standards have been introduced but not practiced by said students.

39. The method of claim 35 wherein a fourth background color appearing in said reports indicates that said content standards have not been introduced to said students.

40. The method of claim 27 further including the step of providing a standards-based item bank and a demographic and test data input.

41. The method of claim 27 further including the step of creating and storing a rationale for each of a plurality of incorrect responses associated with each of a plurality of test items of said standards-based assessment.

42. The method of claim 27 further including the step of scoring said standards-based assessment for providing said assessment result.

43. The method of claim 27 wherein said step of generating a plurality of reports further includes the step of providing a By-Item Report.

44. The method of claim 27 wherein said step of generating a plurality of reports further includes the step of providing a By-Standard Report.

45. The method of claim 27 wherein said step of generating a plurality of reports further includes the step of providing an Item Detail Report.

46. The method of claim 28 wherein said step of identifying the instructional context of said content standards further includes the step of determining if said content standards have been adequately presented to said students during the instructional year.

47. A method for analyzing standards-based assessment data, said method comprising the steps of:
formulating a standards-based assessment of a plurality of academic content standards for administering to a plurality of students, said assessment based upon an existing set of academic content standards;
generating a plurality of reports from administering said assessment for presenting at least one assessment result in a standards-based format, said reports providing a plurality of sections each separately indicating the extent to which said content standards have been presented to said students;
providing a methodology for analyzing said reports for identifying achievement problems of said students; and
setting forth a plurality of parameters for developing an intervention strategy for improving the performance of said students.

48. A method for analyzing standards-based assessment data, said method comprising the steps of:
formulating a standards-based assessment of a plurality of academic content standards and administering said assessment to a plurality of students, said assessment based upon an existing set of academic content standards;
scoring said standards-based assessment for providing at least one assessment result;
generating a plurality of reports for presenting said assessment result in a standards-based format;
providing a methodology for analyzing said reports for identifying achievement problems of said students; and
setting forth a plurality of parameters for developing an intervention strategy for improving the performance of said students.

49. The method of claim 48 further including the step of providing a plurality of sections in said reports, each section separately indicating the extent to which said content standards have been presented to said students.

50. A method for analyzing standards-based assessment data, said method comprising the steps of:
selecting and administering a standards-based assessment of a plurality of academic content standards to a plurality of students, said assessment based upon an existing set of academic content standards;
providing a methodology for analyzing a result of said assessment using a rationale response analysis for detecting achievement problems of said students and for identifying why said students responded incorrectly during said assessment;
providing guidelines for placing said content standards in an instructional context for determining when said content standards were presented to said students; and
setting forth a plurality of parameters for developing an intervention strategy for improving the performance of said students.

51. The method of claim 50 further including the step of providing a plurality of sections in said result of said assessment, each section separately indicating the extent to which said content standards have been presented to said students.

52. The method of claim 50 wherein said step of identifying why said students responded incorrectly during said assessment further includes the step of studying a cognitive rationale of the most predominate student response.

53. A method for analyzing standards-based assessment data, said method comprising the steps of:
formulating a standards-based assessment of a plurality of academic content standards for administering to at least one student, said assessment based upon an existing set of academic content standards;
generating a plurality of reports from administering said assessment for presenting at least one assessment result in a standards-based format;
providing a methodology for analyzing said reports for identifying achievement problems of said student; and
setting forth a plurality of parameters for developing an intervention strategy for improving the performance of said student.
